(19) United States
(12) Patent Application Publication
(10) Pub. No.: US 2023/0397621 A1
(43) Pub. Date: Dec. 14, 2023

(54) METHOD FOR PRODUCING A SOLID INGREDIENT, SOLID INGREDIENT WHICH CAN BE OBTAINED BY IMPLEMENTING SAID PRODUCTION METHOD, AND USES OF SAID INGREDIENT

(71) Applicant: INGREDIA, ARRAS CEDEX (FR)

(72) Inventors: Céline LESUR, Vimy (FR); Audrey ROMELARD, Henin Beaumont (FR); Nassima BELKESSAM, Dainville (FR); Jean-Jacques SNAPPE, Festubert (FR); Franck LAGARDE, La Madeleine (FR)

(73) Assignee: INGREDIA, ARRAS CEDEX (FR)

(21) Appl. No.: 18/033,947

(22) PCT Filed: Oct. 25, 2021
(86) PCT No.: PCT/EP2021/079575

§ 371 Date: Apr. 26, 2023

(30) Foreign Application Priority Data
Oct. 26, 2020 (FR) FR2010961

(51) Int. Cl. A23C 9/12; A23C 19/09; A23L 2/66; A23C 9/154

(52) U.S. Cl. CPC A23C 9/1216; A23C 19/0917; A23L 2/66; A23C 9/154; A23C 2220/10

(57) ABSTRACT

The present invention relates to a method for producing a solid food ingredient, comprising the steps:
i) providing a liquid dairy composition comprising at least 50 wt % caseins relative to its total dry mass, and comprising at most 20 wt % fat(s) relative to its total dry mass;
ii) adding at least one transglutaminase to the composition of step i), at a dose less than or equal to 3 units per gram of total nitrogenous matter (TNM);
iii) at least partially cross-linking the caseins of the liquid composition comprising said at least one transglutaminase;
iv) inactivating said at least one transglutaminase;
v) transforming the liquid composition obtained after step iv) into a solid ingredient.

### TECHNICAL FIELD

The present invention relates to the production of a solid ingredient, in particular a powder, resulting from the transformation of milk proteins, in particular comprising cross-linked micellar caseins, as well as the use of such an ingredient, in particular in the production of dairy products.

### PRIOR ART

It is known to cross-link milk proteins during the production of a dairy food product by using enzymes, such as transglutaminases, in order to improve the production method and/or to modifying the final properties of the food product. Micellar caseins are thus cross-linked under the effect of transglutaminases (TG). The cross-linking of milk proteins is used to form cross-linked food gels, for example for the production of yoghurts.

Transglutaminases are also known to be used in fields other than dairy products, to reconstitute novel forms from meat or fish, or again to strengthen the connectivity between muscles, for example for cooked ham.

In the field of dairy product production, TG are used, in particular, on milk in order to increase its stability, reduce protein sedimentation or again to reduce the clogging of pasteurisers.

U.S. Pat. No. 6,416,797 B1 describes the use of TG in the production of cream cheese in order to limit syneresis. It is thus desired to retain the whey proteins in the structure of the cream cheese in order to avoid a whey separation step and to preserve the nutrients of interest of the whey in the cream cheese.

WO 2015/156672 A1 describes the cross-linking of caseins by TG to improve the thermal stability of a high-protein enteral liquid composition. At a rate of 5 wt % in the composition to be cross-linked of example 1, the TG dose would be several hundred units/g of TNM. According to FIG. 1, during the addition of sodium citrate, the curve representing the size distribution of proteins does not shift, which suggests that almost all the caseins are cross-linked.

Also known are: EP 1 048 218 A2, WO 2010/089381 A2, U.S. Pat. No. 7,267,831 B2, WO 2015/150637 A1 and WO 2018/115594 A1, describing the use of transglutaminase on caseins.

The implementation of cross-linking of micellar caseins by TG in the methods for producing dairy products involves many constraints. Firstly, the duration of the production method is lengthened by the duration of treatment of the micellar caseins by TG. In addition, these steps, which are complex to implement, increase the risk of altering the properties of the final dairy product, if they are poorly executed. Moreover, TG is added to the initial dairy composition, in particular to milk, in such a way that a large proportion of the proteins, or even all of the caseins, in the dairy product will be treated. It can thus be difficult to differentiate the degree of cross-linking, or else it amounts to further lengthening of the duration of the production method, but also its cost.

Moreover, the regulations of certain countries require, in the field of dairy products, the inactivating of TG, which requires the application of a heat treatment to the entire liquid dairy composition intended for the production of a given dairy product.

There is therefore a need to reduce the duration of the production methods for dairy products, to improve the reliability and thus the reproducibility of the properties obtained, while maintaining, or even improving, the organoleptic properties.

In parallel, in order to respond to the nutritional recommendations to eat less fat, less salt and less sugar, there is a need for food products, in particular dairy foods, such as cheeses, yoghurts, ice creams or beverages, having improved nutritional properties and that are, in particular, low-fat or even fat-free and/or protein-rich. Nevertheless, the reduction in fat content of a food product, in particular a dairy product, and/or its enrichment with proteins, can change its functional properties, in particular its sensory properties (taste, appearance, texture, etc.).

Hence, with the aim of improving the functional properties of dairy food products, food ingredients are sought which can be added at various stages of the production of this product.

Thus the present invention relates to a method for producing a food ingredient, in particular a dairy food ingredient, intended to improve the functional properties, in particular sensory properties, of food products, in particular dairy products, and to shorten the production time of the methods for producing said products.

The present invention also relates to a food ingredient, in particular a dairy food ingredient, that can improve the organoleptic properties (texture, viscosity, etc.) of dairy products and/or can be used for replacing known food ingredients, in particular ingredients which are not of dairy origin, for example by replacing gelatine or emulsifying salts.

### DISCLOSURE OF THE INVENTION

The present invention overcomes all or part of the above-mentioned problems, in that it relates, according to a first aspect, to a method for producing a solid food ingredient, in particular in the form of a powder, obtained by a production method comprising the following steps:
i) providing a main liquid dairy composition comprising at least 50 wt % caseins, in particular micellar caseins, relative to its total dry mass, and comprising less than 20 wt % fat(s) relative to its total dry mass;
ii) adding at least one transglutaminase to the composition of step i), at a dose less than or equal to 3 units per gram of total nitrogenous matter (TNM);
iii) at least partially cross-linking the caseins of said liquid composition comprising the transglutaminase;
iv) inactivating, in particular thermally, said at least one transglutaminase;
v) transforming said liquid composition obtained after step iv) into a solid ingredient;
vi) obtaining said solid ingredient.

The ingredient according to the invention advantageously enables the production time of the methods for producing dairy products to be shortened, while having the same advantages: in other words improving certain organoleptic properties, in particular texture/firmness.

The inventors have also observed that the solid ingredient obtained can enable many advantages to be attained: improving the texture, and in particular the firmness, of many types of dairy products comprising it; improving the reproducibility of the texture gain; enabling faster and higher creaming for spreadable processed portions; lowering the viscosity of (high) protein beverages; improving the viscosity retention of (high) protein beverages when they are heated; improving the durability of the viscosity retention (improved storage); enabling gelatine-type texturising agents to be replaced, in particular in the stabilisation of aerated dairy products; and finally enabling the use of emulsifying salt in the production of dairy products to be replaced.

A non-exhaustive explanation of the advantages obtained is that the combination of a low dose of TG per g of TNM with the transformation into solid form makes it possible to obtain a moderate but sufficient cross-linking for the desired functionalities, that is easily reproducible while enabling good dispersion, and thus good availability, of the ingredient in the dairy products.

The ingredient in solid form, in particular in the form of a powder, is then added, at the start or subsequently, to the dairy composition used for the production of a given dairy product. During the implementation of the method for producing the dairy product, it is not necessary to use one or more enzymes for cross-linking the caseins.

The ingredient according to the invention can be used in low concentrations in the dairy product in question, in particular to modify its organoleptic properties and/or its texture and/or its firmness, or at higher concentrations to increase the protein content of the dairy product without altering its viscosity, while improving the longevity of this targeted viscosity and therefore its storage, as well as its resistance to high temperatures.

Transalutaminase

In the present document, a transglutaminase is understood to be an enzyme having a transglutaminase activity which can catalyse the acyl transfer between the gamma-carboxylamide group of a peptide bonded to the glutarine (acyl donor) and primary amines (acyl acceptor), for example a peptide linked to lysine. Free acid amides and amino acids can also react. Proteins and peptides can be cross-linked in this way. This enzyme thus catalyses, in a general manner, the formation of covalent bonds between lysine and glutamine, in particular catalyses the peptide bonds between glutamine residues and lysine residues of the caseins, in particular micellar caseins.

The bonds formed can be of two types: intermolecular bonds comprising the covalent bonds formed between glutamine residues and lysine residues of a same protein or peptide, and intramolecular bonds comprising the covalent bonds formed between glutamine residues and lysine residues between at least two proteins or peptides.

Said at least one transglutaminase (TG) can be obtained from an animal source (for example originating from mammals, poultry, birds, fish), plant source or microbiological source, for example by fermentation.

The group of transglutaminases comprises, but is not limited to, the enzymes assigned to sub-class EC 2.3.2.13.

In the present document, transglutaminase may be indicated by the abbreviation TG.

Preferably, units of TG per gram of TNM, is understood to mean hydroxamate units of transglutaminase per gram of TNM (Total Nitrogenous Matter).

The number of units (U) can be determined by a colourimetric assay which consists in measuring enzymatic activity, in particular using benzyloxycarbonyl-L-glutaminylglycine (CBZ-L-Gln-Gly) and hydroxylamine hydrochloride as substrates. The reaction product is CBZ-L-Gln-Gly-y-monohydroxamate, and one transglutaminase per gram of product analysed (U/g) corresponding to 1 μmole of CBZ-L-Gln-Gly-y-monohydroxamate produced per minute and per gram of product analysed. The CBZ-L-Gln-Gly-y-monohydroxamate produced is measured by absorbance at 525 nm. This method is also designated by the name MOLACTG.

The activity of TG, in U/g of TG, is usually measured and indicated by manufacturer.

Preferably, said at least one TG is marketed under the name ACTIVA® by Ajinomoto Co, Ltd, and can be chosen among ACTIVA® MP, ACTIVA® YG or ACTIVA® SYG, preferably ACTIVA® YG, or even a TG marketed by Novozyme.

Preferably, said at least one TG is produced by a micro-organism, in particular Streptomyces mobaraensis or Bacillus licheniformis.

Preferably, the dose in said at least one transglutaminase is greater than 0 U/g TNM, or greater than or equal to 0.05 g TNM, and less than or equal to 3 U/g TNM, or 2.9 U/g TNM or 2.8 U/g TNM, or 2.5 U/g TNM, or 2.3 U/g TNM or 2 U/g TNM, or 1.8 U/g TNM or 1.5 U/g TNM or 1.3 U/g TNM, or 1 U/g TNM or 0.8 U/g TNM or 0.5 U/g TNM.

The expressions: n*Units or n*U/g TNM shall be understood to mean n units of TG per gram of TNM.

Preferably, the total dose of one or more transglutaminases during step ii) and/or iii), and/or in the method according to the invention, is greater than 0 U/g TNM, or greater than or equal to 0.05 U/g TNM, and less than or equal to 3 U/g TNM, more preferably less than or equal to 2.9 U/g TNM or 2.8 U/g TNM, or 2.5 U/g TNM, or 2.3 U/g TNM or 2 U/g TNM, or 1.8 U/g TNM or 1.5 U/g TNM or 1.3 U/g TNM, or 1 U/g TNM or 0.8 U/g TNM or 0.5 U/g TNM.

Advantageously, obtaining the solid ingredient at step vi) is understood to mean the recovery of the solid ingredient, in particular accessing the transformation device of step v) in order to collect said solid ingredient.

Liquid Dairy Composition

The main liquid dairy composition, in particular at step i), may come from a single liquid dairy composition or from a plurality of mixed liquid dairy compositions. A liquid dairy composition may result directly from a milk filtration method or be reconstituted from casein proteins and/or whey proteins, in particular referred to as native or denatured, preferably native, solid(s), in particular in powder form, which are rehydrated.

In an embodiment, the liquid dairy composition, in particular at step i), and/or the solid ingredient, comprises caseins and whey proteins, preferably the mass fraction of whey proteins relative to the TNM is less than or equal to 20%, more preferably less than or equal to 10%.

In an embodiment, the mass fraction of whey proteins in the liquid dairy composition, in particular at step i), and/or in the solid ingredient, relative to the total nitrogenous matter (TNM) of said composition or said ingredient, is greater than 0%, preferably greater than or equal to 5%, more preferably less than or equal to 20% or 10%.

In an embodiment, the mass ratio of caseins:whey proteins, in the liquid dairy composition, in particular at step i) and/or in the solid ingredient, is from 80:20 to 95:5, in particular from 85:15 to 95:5, more particularly from 90:10 to 95:5.

Advantageously, a mass ratio of caseins:whey proteins of x:y is understood to mean that the liquid composition or the solid ingredient comprises x g of caseins for y g of whey proteins.

The various techniques for filtration of milk, in particular for obtaining at least one dairy protein concentrate rich in caseins, in particular micellar caseins, in particular native micellar caseins, or rich in whey proteins, in particular native whey proteins, are well-known to a person skilled in the art, and can be implemented in order to obtain at least one liquid or powder protein concentrate then rehydrated, used in the present invention.

Preferably, the liquid composition, in particular at step i) and/or ii) and/or iii) and/or iv), comprises water, more preferably the mass fraction of water in the liquid composition is greater than or equal to 80%, preferably greater than or equal to 85%.

Preferably, the water in the liquid dairy composition comprises/is osmosis-purified water.

In an embodiment, the mass ratio TNM/TDM (total dry mass) of the main liquid composition, in particular at step i) and/or ii) and/or iii) and/or iv), or of the solid food ingredient, is greater than or equal to 60%, or greater than or equal to 70%, or preferably greater than or equal to 80% or even greater than or equal to 90%.

Preferably, the caseins defined in the present document are micellar caseins, in particular native micellar caseins, at step i) and/or ii) and/or iii) and/or iv) and/or in the solid ingredient obtained.

The caseins are preferably native micellar caseins (i.e. not having undergone enzymatic and/or chemical and/or mechanical denaturation, for example by adding one or more acids and/or coagulant enzymes) and/or application of a very high pressure.

In a preferred embodiment, the liquid dairy composition, in particular at step i), comprises/is at least a liquid retentate from at least one step of membrane filtration of milk, in particular chosen among: an ultrafiltration step, a microfiltration step and a diafiltration step, or a combination of these, preferably a membrane microfiltration step. The retentate may undergo one or more protein concentration steps (for example by evapoconcentration) and/or protein dilution.

Preferably, said retentate has not undergone a spray drying step.

In an embodiment, the liquid dairy composition, in particular at step i), comprises/is a liquid isolate of milk proteins.

In an embodiment, the liquid dairy composition, in particular at step i), comprises/is at least a solid rehydrated retentate resulting from at least one step of membrane filtration of milk, in particular such as described above.

Preferably, the micellar caseins are not and/or do not comprise caseinates (which are denatured caseins).

In an embodiment, the mass ratio caseins/TNM of the main liquid composition, in particular at step i) and/or ii) and/or iii) and/or iv), and/or in the solid food ingredient obtained, is greater than or equal to 60%, or 70%, preferably greater than or equal to 80%, more preferably greater than or equal to 90%.

In an embodiment, the mass ratio caseins/TDM (total dry matter) of the liquid composition, in particular at step i) and/or ii) and/or iii) and/or iv) and/or in the solid ingredient obtained, is greater than or equal to 50% or 60%, or 70%, preferably greater than or equal to 80%, more preferably greater than or equal to 90%.

In an embodiment, the mass ratio lactose/TDM (total dry matter) of the liquid composition, in particular at step i) and/or ii) and/or iii) and/or iv) and/or in the solid ingredient obtained, is greater than or equal to 0%, preferably less than or equal to 10%, more preferably less than or equal to 6%.

The mass fraction of the total dry mass (TDM) of the liquid composition (relative to the total mass of the liquid composition, including water), in particular at step i) and/or ii) and/or iii) and/or iv), is greater than or equal to 1% and less than or equal to 20%, preferably greater than or equal to 5% and less than or equal to 20%, more preferably is in the range [7%; 17%].

The mass fraction of TNM (Total Nitrogenous Matter) of the liquid composition (i.e. relative to the total mass of the liquid composition, including water), in particular at step i) and/or ii) and/or iii) and/or iv), is greater than or equal to 1% and less than or equal to 20%, preferably greater than or equal to 5% and less than or equal to 20%, more preferably less than or equal to 15%, for example in the range [7%; 15%].

In an alternative, the solid food ingredient is obtained by a method comprising a single step of transformation of a liquid into a solid, in particular a single spray drying step.

In an alternative, in particular at step i) and/or at step ii) and/or at step iii) and/or at step iv), the liquid composition, and/or the solid ingredient, comprises at most 20 wt %, or at most 15 wt % fat(s) relative to its total dry mass.

### Definitions

The masses of proteins, caseins, whey proteins, TNM, fat, lactose and minerals, in the liquid composition or the ingredient, are the dry masses of these components.

In the present document, dairy ingredient or liquid dairy composition are understood to mean any ingredient or liquid composition comprising one or more solid or liquid components originating from milk, in particular comprising milk proteins, in particular caseins and whey protein.

Milk

According to the definition in the CODEX Alimentarius, milk is the normal mammary secretion of milking animals, obtained from one or more milkings, without anything added or subtracted, intended for consumption, such as, for example, liquid milk, or at a later treatment (for example cheese production).

The designation “milk” without any indication of the animal species, is, according to French legislation, reserved for cows milk. Any milk coming from a dairy female other than a cow must be designated by the designation “milk” preceded by an indication of the animal species from which it comes, for example: goat milk, sheep milk, donkey milk, buffalo milk.

In the context of the present invention, the term “milk” designates milk originating from a milking animal whatever the indication of the animal species.

Milk Proteins

Preferably, according to the definition in the CODEX Alimentarius, milk proteins are defined as dairy products containing a minimum of 50% milk proteins, calculated as a function of the dry matter (nitrogen×6.38). The total nitrogenous matter (TNM) thus comprises the milk proteins and the non-protein nitrogenous matter.

The milk proteins comprise caseins and whey proteins. Caseins represent at least 80 wt % of the total mass of milk proteins. The whey proteins represent at least 20 wt % of the total mass of milk proteins.

Casein Proteins

Caseins are organic complexes consisting of casein proteins in the form of a loose and tangled chain which fixes calcium phosphate by chemical bonds. These proteins have a low level of secondary organisation (in helices a or in sheets P). The caseins are organised in micelles: these are spherical particles formed by the combination of various caseins. The organisation of a micelle, in other words the arrangement and distribution of the different constituents as well as their modes of combination, are always hypothetical. The uncharged parts of the caseins will form rigid structures maintained by hydrophobic combinations and hydrogen bonds. Calcium phosphate acts as a cement which enables the combination of the caseins into micelles. The casein K would be distributed in heterogeneous packets, located almost exclusively at the surface of the micelles. Casein K is combined with the micelle by its hydrophobic N-terminal part, whereas its hydrophilic C-terminal part forms protuberances of 5 to 10 nm projected into the aqueous phase and thus giving the micelle a “scalp” appearance. The milk proteins that remain after isoelectric precipitation of the caseins are whey proteins.

Whey

Whey is the liquid part resulting from the coagulation of milk. Two types of whey can be distinguished: those resulting from the production in an acid medium of caseins or fresh cheeses (acid whey); and those resulting from the manufacture of caseins using rennet and cooked or semi-cooked pressed cheeses (sweet whey). Whey can comprise vitamins (in particular thiamine-B1, riboflavin-B2 and pyridoxine-B6), and minerals (essentially calcium).

Milk Whey Proteins

Milk whey protein, also referred to as native or undenatured milk whey protein, may result from a liquid cheese-making whey (by-product of cheese production) or again be obtained by (ultra)(micro)filtration, in particular membrane filtration, of milk, or rehydration of a powder, for example of a powder of a protein whey concentrate.

A protein whey concentrate resulting from cheese production, in particular in its liquid form, is a fraction of the whey from which the lactose has been partially removed in order to increase the dry mass proportion of whey proteins to at least 25 wt %, preferably at least 30 wt %, over the total mass of the protein whey concentrate. Preferably, the whey proteins are mainly constituted of β-lactoglobulin and α-lactalbumin proteins. They can also comprise immunoglobulins, bovine serum albumin, lactoferrin and enzymes (lipases, proteases, etc.).

Test Methods

In the present document, dry extract by mass or total dry mass (TDM) is understood to mean the dry mass of a liquid mixture, concentrate or composition, obtained after evaporation of the water until a stable total dry mass is obtained. The total dry mass is preferably calculated using standard ISO 6731: January 2011, “Milk, cream, and unsweetened condensed milk—Determination of dry matter (Reference method)”.

The following standards can be used within the context of the invention in order to determine, in particular, masses of TNM, proteins and ash: ISO 8968-1/2014 “Milk and milk products—Determination of nitrogen content—Part 1: Kjeldahl principle and crude protein calculation”; NF EN ISO 8968-3 Oct. 2007 “Milk—Determination of nitrogen content—Part 3: Block-digestions method”; NF EN ISO 8968-4/June 2016 “Milk and milk products—Determination of nitrogen content—Part 4: determination of protein and non-protein nitrogen content and true protein content calculation”; NF V04-28 Oct. 1989 “Milk—Determination of ash—Reference method”.

In general, a powder protein concentrate, or the solid ingredient according to the invention, has a dry mass, for example according to the standard defined above, comprising at most 6 wt % water.

In an embodiment, the ingredient obtained is solid, in particular in the form of a powder.

In an embodiment, the temperature of the liquid composition at step i) and/or ii) is greater than or equal to 0° C. and less than 55° C., preferably less than or equal to 50° C., in particular greater than or equal to 30° C.

In an alternative, the liquid composition at step i) and/or ii) and/or iii) and/or iv) and/or v) has a pH greater than or equal to 5.0, preferably greater than or equal to 6.0, more preferably less than or equal to 7.5, preferably greater than or equal to 6.5 and less than or equal to 7.5 or 7.0.

These pH ranges are optimised for the optimum function of the enzyme TG. Indeed, a pH less than 5 or greater than 7.5, slows the enzymatic activity of TG.

In an alternative, the temperature of the liquid composition at step iii) is greater than or equal to 0° C. and less than or equal to 55° C., preferably less than or equal to 50° C., in particular greater than or equal to 30° C.

This step iii) preferably comprises holding the liquid composition at a temperature in the range [30° C.; 50° C.], in particular in the range [35° C.; 45° C.].

In an alternative, the duration of step iii) is greater than or equal to 30 minutes, preferably less than or equal to 12 hours.

The duration of the cross-linking is a function of the temperature at which the liquid composition is held.

The higher the temperature, the shorter will be the duration of the treatment by TG.

In an embodiment, the duration of step iii) is greater than or equal to 2 hours, preferably 4 hours, and less than or equal to 8 hours, and the liquid dairy composition is held at a temperature greater than or equal to 20° C., preferably greater than or equal to 30° C., and less than or equal to 50° C.

The inventors consider, in a non-limiting manner, that this embodiment makes it possible to obtain homogeneous and progressive cross-linking.

In an alternative, said method comprises a step of pasteurisation of the liquid composition of step i), before step ii).

In an alternative, the method comprises heating the liquid composition of step i), before step ii), to a temperature greater than or equal to 70° C., preferably greater than or equal to 80° C. or 85° C. for at least 1 second, preferably for at least 30 seconds, more preferably for at least 1 minute, in particular at least 1 minute 30 seconds, for example of order 2 minutes.

Preferably, the heating temperature is less than or equal to 95° C.

Preferably, it involves a pasteurisation step.

The aim of this step is to improve the microbial stability of the liquid composition before its treatment with TG. Indeed, the cross-linking step iii) comprises holding the liquid composition at a temperature and for a duration which can be conducive to the growth of bacteria.

In an alternative, step iv) of inactivating said at least one transglutaminase comprises: a step of heating the liquid composition to a temperature greater than or equal to 55° C., and/or a step of adjusting the pH of the liquid composition to a pH less than or equal to 5.0 or 4.5 or 4.0, or to a pH greater than or equal to 7.0 or 7.5 or 8.0, and/or by cooling the liquid composition to a temperature less than or equal to 30° C. or 25° C. or 20° C. or 10° C.

The duration of step iv) is a function of the intensity of the selected inactivation treatment.

In a preferred alternative, the step of inactivating said at least one transglutaminase comprises heating the liquid composition to a temperature greater than or equal to 60° C. or 65° C. or 70° C. or 75° C. or 80° C.

During the inactivation step, the temperature is preferably less than or equal to 110° C., in particular less than or equal to 100° C. or 90° C.

The duration of the inactivation step treatment is greater than or equal to 1 second, preferably greater than or equal to 5 seconds or 10 seconds or 30 seconds or even 40 seconds or 60 seconds.

The duration of the treatment of step iv) is preferably less than or equal to 10 minutes, more preferably less than or equal to 5 minutes.

In an alternative, step v) comprises a spray drying step, in particular a preliminary step of concentrating the total dry matter of the liquid composition.

The inventors have observed that this step reduces the quantity of proteins, in particular cross-linked caseins, having molecular weights greater than 400,000 daltons. However, the solid ingredient can improve many properties of dairy products compared with a liquid ingredient (see tests below).

In a non-limiting manner, this step contributes to improving the distribution of molecular weights of cross-linked proteins.

The spray drying step and the concentration step, for example by evaporation, are well-known steps for a person skilled in the art.

In an alternative, the degree of cross-linking of proteins, in particular caseins, in the liquid composition after step iii), in particular after step iv), is greater than 0% and less than or equal to 70%, preferably less than or equal to 65% or 60% or 55% or 50%, more preferably less than or equal to 45%.

Preferably, the degree of cross-linking of proteins, in particular caseins, in the liquid composition after step iii), in particular after step iv), is greater than or equal to 15%, more preferably greater than or equal to 20%, preferably greater than or equal to 25%, in particular greater than or equal to 30%. The method for calculating this degree is described in the experimental part.

Advantageously, this degree of cross-linking is moderate. Usually, the proteins are entirely cross-linked, especially when the cross-linking takes place during the method for producing the dairy product, this method being more difficult to control.

In an alternative, in particular at step i) and/or at step ii) and/or at step iii) and/or at step iv), the liquid composition, and/or the solid ingredient, comprises at most 10 wt % fat(s) relative to its total dry mass.

Preferably, the mass ratio of fat(s) (F)/Total dry matter (TDM) of the liquid composition, in particular at step i) and/or at step ii) and/or at step iii) and/or at step iv), or of the solid food ingredient, is less than or equal to approximately 7%, or 5% or 4% or 3% or 2%.

The ingredient advantageously comprises little fat, which facilitates its addition in dairy products with low fat contents.

In an alternative, in particular at step i) and/or at step ii) and/or step iii) and/or step iv), the liquid composition comprises at least 70 wt % of total nitrogenous matter relative to its total dry mass (TDM).

In an alternative, the ingredient obtained at step vi) comprises at least 70 wt % total nitrogenous matter (TNM) relative to its total dry mass.

In an alternative, the ingredient obtained at step vi) comprises at least 80 wt % caseins relative to its total dry mass.

In an alternative, in particular at step i) and/or at step ii) and/or at step iii) and/or at step iv), the liquid composition comprises at least 1 wt % or 2 wt %, preferably at least 2.4 wt %, calcium relative to its total dry mass.

In an embodiment, in particular at step i) and/or at step ii) and/or at step iii) and/or at step iv), the liquid composition comprises at most 3.5 wt %, in particular at most 3.0 wt %, calcium relative to its total dry mass.

In an alternative, the ingredient obtained at step vi) comprises at least 1 wt % or 2 wt %, preferably at least 2.4 wt %, calcium relative to its total dry mass.

In an embodiment, the ingredient obtained at step vi) comprises at most 3.5 wt %, in particular at most 3 wt %, calcium relative to its total dry mass.

In an alternative, less than 60% of the proteins of the liquid composition after step iii), in particular after step iv), have molecular weights greater than or equal to 400,000 daltons.

In an embodiment, less than 50% of the proteins in the liquid composition after step iii), in particular after step iv), have molecular weights greater than or equal to 400,000 daltons.

In an embodiment, between 10% and 50%, preferably between 20% and 50%, more preferably between 30% and 50%, of the proteins in the liquid composition after step iii), in particular after step iv), have molecular weights greater than or equal to 400,000 daltons (upper and lower bounds included).

In an embodiment, between 50% and 80% (bounds included) of the proteins in the liquid composition after step iii), in particular after step iv), have molecular weights less than or equal to 400,000 daltons.

In an alternative, less than 50% of the proteins, in particular caseins, of the solid ingredient have molecular weights greater than or equal to 400,000 daltons.

In an embodiment, between 10% and 50%, preferably between 10% and 40%, more preferably between 20% and 40%, of the proteins of the solid ingredient have molecular weights greater than or equal to 400,000 daltons (upper and lower bounds included).

In an embodiment, between 50% and 80% (bounds included), preferably between 60% and 80% (bounds included), of the proteins of said ingredient have molecular weights less than or equal to 400,000 daltons.

The method for determining molecular weights and their distributions are indicated in the experimental part.

In an alternative, the degree of cross-linking of the proteins, in particular caseins, in the solid ingredient is greater than 0% and less than or equal to 70%, preferably less than or equal to 55% or 50% or 45%.

Preferably, the degree of cross-linking of the proteins, in particular caseins, in the solid ingredient is greater than or equal to 15%, more preferably greater than or equal to 20%, preferably greater than or equal to 25%, in particular greater than or equal to 30%. The method for calculating this degree is described in the experimental part.

In an alternative, the D50 by cumulative volume of the particles, in particular proteins, of the solid ingredient is greater than or equal to 1 μm, preferably greater than or equal to 10 μm, more preferably greater than or equal to 15 or 20 μm.

In an alternative, the D10 by cumulative volume of the particles, in particular proteins, of the solid ingredient is greater than or equal to 1 μm, preferably greater than or equal to 5 μm.

In an alternative, the D90 by cumulative volume of the particles, in particular proteins, of the solid ingredient is greater than or equal to 30 μm, preferably greater than or equal to 50 μm, more preferably greater than or equal to 70 μm.

In an alternative, the D[4, 3] by cumulative volume of the particles, in particular proteins, of the solid ingredient is greater than or equal to 1 μm, or 5 μm or 10 μm or 20 μm, preferably greater than or equal to 30 μm.

Advantageously, the solid ingredient very largely comprises proteins such that the size of the particles and the molecular weight of the particles are considered as similar to those of proteins.

By Dx it should be understood that x % of particles by cumulative volume have sizes greater than or equal to the value of Dx.

Thus, for D50, 50% by cumulative volume of particles have sizes greater than or equal to the value of D50, and the remaining 50% by cumulative volume have sizes less than or equal to the value of D50.

The size of particles is preferably determined by static light scattering using a Mastersizer 3000 particle size analyser (Malvern Instruments Limited, Malvern, UK). The apparatus is equipped with a He/Ne laser with a power of 4 mW and operates at a wavelength of 632.8 nm. The size of the particles detected by this system is between 0.1 μm and 3500 μm. The measurement is preferably carried out on an ingredient dissolved in water, with 2% total proteins.

The object of the present invention, according to a second aspect, is a solid food ingredient, in particular a solid dairy food ingredient, comprising at least 50 wt % caseins, and at most 20 wt % fat(s), at least part of the caseins are cross-linked, and at most 50% of the proteins of said solid ingredient have molecular weights greater than or equal to 400,000 daltons.

The percentages by weight indicated in the present document with respect to the ingredient are calculated relative to the total dry mass of the solid ingredient.

The alternatives and embodiments indicated above relating to the solid ingredient according to a first aspect of the invention can apply independently of one another to the solid food ingredient according to a second aspect of the invention, and vice versa.

The object of the present invention according to a third aspect, is a solid ingredient that can be obtained by the production method according to a first aspect of the invention.

In an alternative, the degree of cross-linking of the proteins, in particular caseins, in the solid ingredient is greater than 0% and less than or equal to 60%, preferably less than or equal to 45%.

Preferably, the degree of cross-linking of the proteins of the solid ingredient is greater than or equal to 15%, more preferably greater than or equal to 20%, preferably greater than or equal to 25%, in particular greater than or equal to 30%.

The alternatives and embodiments indicated above relating to the solid ingredient according to a first aspect of the invention or a second aspect of the invention, can apply independently of one another to the solid food ingredient according to a third aspect of the invention.

The object of the present invention according to a fourth aspect, is the use of the solid ingredient, with reference to the first aspect or second aspect or third aspect of the invention:
for producing a dairy product chosen from:
list I consisting of: stirred yoghurts, steamed yoghurts, thermised yoghurts, drinkable yoghurts, yoghurt foams, stirred and steamed fermented milks, soft cheeses, fromage frais, pasta filata cheeses, spreadable cheeses, uncooked pressed cheeses, semi-cooked pressed cheese, cooked pressed cheese, and any dairy product obtained by implementing a method comprising a step of coagulation during which the pH is lowered, or a combination thereof; in particular from acidified and/or fermented dairy products; preferably in the list consisting of: steamed yoghurts, optionally low-fat; block cheeses for slicing, optionally without emulsifying salt; processed fromage frais; cream cheeses; fromage frais foams, optionally without thickener and/or
list II consisting of: dairy products not comprising a step during which the pH is lowered, in particular processed cheeses, spreadable processed cheeses, ice creams and cream desserts, or a combination thereof; preferably spreadable processed cheeses, and/or
in list III consisting of: protein beverages, protein gels, protein bars, extruded products, or a combination thereof, preferably protein beverages, in particular high-protein beverages.

In an alternative, the dairy product is chosen from list I and/or list II, and the mass fraction of said solid ingredient relative to the total mass of said dairy product is greater than 0% and less than or equal to 30% or 20% or 10%.

In an alternative, the dairy product is chosen from block cheeses for slicing, with or without emulsifying salt, and the mass fraction of said solid ingredient relative to the total mass of said dairy product is greater than or equal to 10%, in particular greater than or equal to 10% and less than or equal to 20%, or greater than or equal to 30% or 40% and less than or equal to 60% or 55%.

In an alternative, the dairy product is chosen from list III, and the mass fraction of said solid ingredient relative to the total mass of said dairy product is greater than or equal to 10% and less than or equal to 30%, in particular less than or equal to 20%.

In an embodiment, the dairy product chosen from list III, in particular a protein beverage, has an energy less than or equal to 100 kcal per 100 g.

In an embodiment, the dairy product chosen from list III, in particular a protein beverage, has a mass concentration of proteins greater than or equal to 8% or 10% and less than or equal to 18%, preferably less than or equal to 17.5%, more preferably less than or equal to 17%.

Here, the mass concentration of proteins is the ratio of the mass of proteins relative to the total mass of the protein beverage.

Preferably, the (high) protein beverage comprises the solid ingredient according to the invention and milk, in particular said solid ingredient is dispersed in the milk.

The proteins are those provided by the ingredient according to the invention, in particular caseins, but also those provided by the other components of the dairy product, such as milk, in particular skimmed milk. These other proteins can be whey proteins and/or caseins.

Preferably, the protein beverage comprises milk, optionally skimmed or semi-skimmed, and the dispersed solid ingredient.

In an embodiment, the dairy product chosen from list III, in particular a protein beverage, comprises at most 2 g fat per 100 g of said dairy product, preferably at most 1 g of fat per 100 g of said dairy product, more preferably at most 0.5 g of fat per 100 g of said dairy product.

In an embodiment, the dairy product chosen from list III, in particular a protein beverage, comprises at most 5 g, or 4 g, or 3 g, or 2 g, or 1 g of carbohydrate(s) per 100 g of said dairy product, preferably at least 0.5 g, or 1 g, or 1.2 g of carbohydrate(s) per 100 g of said dairy product.

In an embodiment, the dairy product chosen from list III, in particular a protein beverage, has a pH in the range [5.5; 7.0], preferably in the range [6.0; 7.0], more preferably in the range [6.4; 7.0].

In an embodiment, the dairy product chosen from list III, in particular a protein beverage, comprises between 0 mg and 600 mg, or between 0 mg and 550 mg, or between 100 mg and 550 mg, or between 200 mg and 550 mg, or between 300 mg and 550 mg, or between 350 mg and 550 mg, of calcium for 100 g of said dairy product (upper and lower bounds included).

In an embodiment, the dairy product chosen from list III, in particular a protein beverage, comprises between 0 mg and 500 mg, or between 0 mg and 400 mg, or between 100 mg and 400 mg, or between 200 mg and 400 mg, of phosphorus per 100 g of said dairy product (upper and lower bounds included).

In an embodiment, the dairy product chosen from list III, in particular a protein beverage, is sterilised at very high temperature, in particular at a temperature greater than or equal to 100° C., or 110° C., or 120° C., or 130° C. or 140° C., in particular for at least one second (preferably for less than 30 seconds, or for less than 15 seconds).

In an embodiment, the dairy product chosen from list III, in the liquid state, in particular a protein beverage, has a viscosity less than or equal to 200 mPa·s, in particular measured at 20° C., preferably less than or equal to 100 mPa·s.

The viscosity measurements in this document are preferably performed using a Viscotester IQ Air (HAAKE Viscotester IQ Air) viscometer, preferably at a temperature of 20° C. and at a shear speed (i) at 200.0 l/s, in particular with a reference module TM-PE-C32.

It is considered that these viscosity ranges allow easy oral consumption.

These viscosity ranges are advantageously durably maintained even after a thermal treatment by heating, for example with the aim of sterilising the dairy product.

Too high a viscosity has the disadvantage that the production machines can clog up, indeed some areas of the latter may become clogged or blocked, in particular during the sterilisation method, in particular at UHT (ultra-high temperature).

An object of the present invention, according to a fifth aspect, is the use of the solid ingredient, with reference to first aspect or second aspect or third aspect of the invention as texturising agent of a dairy product, in particular having undergone an aeration and/or by replacing a stabiliser or a thickener, in particular chosen from the list consisting of: gelatine; gums, such as locust bean gum, guar gum, xanthan gum, Arabic gum; cellulose derivatives, such as finely divided cellulose and carboxymethyl cellulose; starches, such as corn starch, rice starch, potato starch, tapioca starch, wheat starch, and sweet potato starch; and modified starches, such as phosphorylated starch; pectins, or the carrageenans, or a combination thereof, in particular gelatin. The above-mentioned starches are, for example, in the form of a starch of the targeted plant.

An object of the present invention, according to a sixth aspect, is the use of the solid ingredient, with reference to the first aspect or second aspect or third aspect of the invention as an agent for improving the fluidity of protein beverages, in particular high-protein beverages.

An object of the present invention, according to a seventh aspect, is the use of the solid ingredient, with reference to the first aspect or second aspect or third aspect of the invention, as an agent for the production of processed cheeses without emulsifying salt.

An object of the present invention, according to an eighth aspect, is a protein beverage comprising a solid ingredient according to the invention, in particular according to any one of the preceding aspects.

In particular, any one of the alternatives or embodiments described with reference to the fourth aspect of the invention also applies to the protein beverage according to an eighth aspect of the invention.

The alternative embodiments, definitions and steps according to a first aspect of the invention can be combined, independently of one another, with alternatives according to a second and/or third and/or fourth and/or fifth and/or sixth and/or seventh and/or eighth aspect(s).

### DESCRIPTION OF THE DRAWINGS

The invention will be better understood upon reading the following description of embodiments of the invention, given as non-limiting examples and with reference to the attached figures, wherein:

FIG. 1 is a graph showing the elution profile of a control liquid composition comprising native non-cross-linked caseins A;

FIG. 2 is a graph showing the elution profile of an exemplary rehydrated solid ingredient (B) according to the invention;

FIG. 3 is a table showing the values of DP and Delta DP for a control (A) comprising caseins that are not cross-linked by TG, and ingredients according to the invention B, B1, B2 and B3;

FIG. 4 is a table showing the distribution of molecular weights of a control liquid composition comprising native non-cross-linked caseins A before spray drying, and of the liquid composition B obtained according to the invention at step iv) and therefore before its transformation into a solid;

FIG. 5 is a table showing the distribution of molecular weights of a control liquid composition comprising native non-cross-linked caseins A after spray drying (then rehydration for the tests) designated as ingredient A, and rehydrated solid ingredients B, B2, and B3 for the tests in an aqueous solution at 10% total proteins (thus obtained at step vi);

FIG. 6 is a curve showing the particle size distribution as a function of their accumulated volumes in the ingredients A, B and B1; the size is studied in an aqueous solution at 2% total proteins;

FIG. 7 is a table showing the compositions and the results of the tests on low-fat set yoghurts A to D;

FIG. 8 is a table showing the compositions and the results of the tests on block cheeses to be sliced A, B and C;

FIG. 9 is a table showing the compositions and the results of the tests on spreadable processed cheese aluminium triangle portions A, B and C;

FIG. 10 is a graph showing the development of the creaming during the production of spreadable processed cheeses A, B and C;

FIG. 11 is a table showing the compositions and the results of the tests on block cheeses to be sliced A, B and C, without emulsifying salt.

FIG. 12 is a table showing the compositions of high-protein beverages A, B and C;

FIG. 13 is a histogram showing the viscosity is measured on the high-protein beverages A, B and C after their production;

FIG. 14 is a photograph showing, from left to right, the high-protein beverages A, B and C, after sterilisation at UHT, upside down, after one month of storage;

FIG. 15 is a histogram showing the viscosities measured on the high protein beverages A, B and C before UHT sterilisation (ultra-high temperature), then 4 and 21 days after UHT sterilisation;

FIG. 16 is a histogram showing the viscosities measured on the high protein beverages B at protein mass concentrations of 15% and 17% after UHT sterilisation, at 1, 7 and 21 days;

FIG. 17 is a table showing the compositions of aerated fromage frais A, A11 and B;

FIG. 18 is a histogram showing the change in firmness (g) at 1 day and at 14 days for the aerated cheeses A, A11 and B;

FIG. 19 shows the sensory analysis of aerated cheeses A, A11 and B;

FIG. 20 is a table showing the compositions and the results of the so-called “cream cheese” cheeses A, B and C;

FIG. 21 is a table showing the compositions and results for processed fromage frais A, B and C.

### DESCRIPTION OF THE EMBODIMENTS

I—Example of Production of a Solid Ingredient According to the Invention

A liquid composition is prepared from a liquid casein concentrate, in particular native micellar caseins, having a dry extract by weight of 10.5%, a pH of order 6.9, a mass ratio TNM/DM (dry matter) of order 86%; and a mass ratio micellar caseins/TNM of order 92% (step i). This casein concentrate is, in particular, a retentate of a membrane microfiltration step of milk, more particularly not having undergone a transformation step from a liquid into a solid. The mass ratio of whey proteins/TNM is less than or equal to 10%, for example of order 8%. The mass ratio of fat(s)/DM (dry matter) is, in this specific example, of order approximately 2%.

The liquid composition preferably undergoes a thermal treatment during which it is heated, in particular it undergoes pasteurisation, in this specific example at a temperature of order 85° C. for 2 seconds. Said liquid composition is then preferably cooled to a temperature between 35° C. and 45° C., in this specific example to approximately 38° C.

A determined dose of transglutaminase protein is then added to this liquid composition at approximately 38° C., in particular a dose of 0.40 U/g of TNM (step ii). This is preferably the transglutaminase protein “Activia YG” from Ajinomoto having an activity in this specific example of 110 units per gram of TG. The number of units is indicated by the manufacturer according to the production batch and can vary slightly, for example of order+/−20 units per gram of TG. The proportion by weight of TG is determined according to the dose in units of TG per g of TNM that it is desired to add, in this case 0.40 U/g of proteins. Said liquid composition then undergoes a thermal treatment (step iii) by maintaining the liquid composition at a determined temperature, in particular approximately 38° C., for a determined period, preferably between 5 hours and 7 hours, in this specific example of order 6 hours 30 minutes, in order to at least partially cross-link the caseins.

Preferably, a thermal treatment is applied to the liquid composition treated with TG in order to inactivate the TG (step iv)), the liquid composition is heated to a determined temperature, preferably of order 75° C., for a determined period, preferably of order 5 minutes.

Finally, a step of concentration and spray drying is applied to the resulting final liquid composition, in order to obtain a solid ingredient B, in the form of a powder (step v) and vi)).

An ingredient B1 according to the invention is produced according to the same recipe and the same method but with a different TG: CAS Number 80146-85-6, marketed by Novozyme.

Another ingredient according to the invention B2 is produced according to the same recipe and the same method as ingredient B, but the dose of TG is 1 Ug/TNM.

Another ingredient B3 is produced according to the same recipe and the same method as ingredient B, but the dose of TG is 3 Ug/TNM.

FIG. 6 shows the analysis of the particle size distribution: 1/ for an ingredient A obtained by the same recipe and the same method as for ingredient B but without adding TG and thus without cross-linking by a TG; 2/ for an ingredient B; and 3/ for an ingredient B1.

This measurement is carried out on an ingredient in solution at 2 wt % of proteins (5 minutes of reconstitution, 60 minutes at 50° C. for rehydration in an oven, rehydration continues cold at 4° C.) with a laser particle size analyser, Malvern Mastersizer 3000 (cf. information above).

The D10, D50 and D90 (by volume) of ingredient A are 0.0531 μm, 0.159 μm and 3.98 μm respectively.

The D10, D50 and D90 (by volume) of ingredient B are 23.9 μm, 72.6 μm and 148 μm respectively.

The D10, D50 and D90 (by volume) of ingredient B1 are 8.49 μm, 28.5 μm and 82.6 μm respectively.

The particles of ingredients B and B1 according to the invention have significantly larger sizes than those of ingredient A. In particular, the D50 of ingredient B or B1 is several hundred times greater than the D50 of ingredient A.

II—Test Methods

1—Determination of the Degree of Cross-Linking (%) of Proteins by TG, and Molecular Weights of Proteins of the Ingredient According to the Invention and the Liquid Composition Treated According to the Invention

a) Preamble

The measurements below are carried out using a low pressure liquid chromatography system (in this case: Akta Pure, in particular AKTA FPLC (Fast Protein Liquid Chromatography) marketed by GE Healthcare). Two separate integration software are used on this system in order to determine: 1/ Delta DP or Delta of the Degree of Polymerisation (Unicorn 7.02 software from GE Healthcare); 2/ the distribution of molecular weights (specific software from PSS-Polymer, Germany).

The chromatographic protocol for analysis of samples was validated using validated information in the publication: “Effect of transglutaminase-treated milk powders on the properties of skim milk yoghurt” C. Guyot, U. Kulozik (International Diary Journal 21, (2011) 628-635). The chromatography system is used with a UV detection system and a Superdex™ 200 10/300 gel filtration column (GE Healthcare) enabling the characterisation of proteins having a molecular weight between 10,000 and 600,000 daltons. The elution buffer used was composed of: 6 mol/L urea (Ref. Merks CAS 57-13-6); 0.1 mol/L sodium chloride (Ref. Chem-Lab CAS 7647-14-5); 0.1 mol/L sodium phosphate (Ref. Chem-Lab CAS 13472-75-09). The column is first equilibrated with the cited buffer for 4 hours (conditions supplied with the equipment). Then, the samples are manually injected (volume=100 μL). The solid ingredients to be tested are always rehydrated according to the same experimental conditions: a) Reconstitution of a solution at 10% TNM at 50° C.; b) Hydration for 1 hour always at 50° C.; c) Homogenisation at 200 bar and 70° C. A control A (raw material not treated with transglutaminase) is analysed for each series of samples so as to determine the degree of polymerisation of the matrix, and to compare the change over time of the molecular weight distribution.

b) Determination of the Delta of DP (Degree of Cross-Linking)

The Delta DP or Delta of the Degree of Polymerisation (also defined in this document as degree of cross-linking) is defined as being the percentage of bonded proteins, in particular bonded caseins, relative to the overall protein content in the sample. This method is inspired by the whey exclusion chromatography method described in the above cited publication.

The chromatographic profiles obtained following the injection of the samples are analysed using the Unicorn 7.02 software from GE Healthcare. Each of the peaks (for example references A to F in tables 3 and 4), observed on the chromatogram of the analysed sample, are integrated. According to the following elution profile, we observed: 1) Oligomers/Trimers; 2) Dimers, and 3) Monomers. The molecules with the smallest sizes (monomer) leave last. The response of the UV signal is a function of the particle sizes. The area corresponds to the area of the peak, and it is expressed in Retention volume (mL)*Peak height (mAU). The modifications of the medium are measured with the increase in the area of the peaks of the high molecular weights, and the reduction in that of the monomers. The degree of polymerisation (DP) is measured on the basis of the ratio of (the area of the proteins, in particular the area of the bonded caseins, corresponding to the sum of the areas for the dimers, trimers and oligomers) over (the area of total proteins, in particular total caseins, corresponding to the sum of the areas of all the proteins present, in particular all the caseins present, (including the monomers)). Delta DP is finally calculated as: DP for the sample for which it is desired to evaluate the degree of cross-linking (for example the ingredient according to the invention B, or B1 or B2 or B3)—DP for the control (not treated with TG). Delta DP is thus representative of the bonds created following the treatment with TG, between the proteins, in particular between the caseins, of the liquid composition.

The value of the degree of cross-linking or Delta DP for ingredient B according to the invention is 34.7%. A statistical study was performed so as to determine the coefficient of variation over the measurement, which is of order 10%. A degree of cross-linking of approximately 29% was observed for ingredient B2 and approximately 44% for ingredient B1. The degree of cross-linking for ingredient B3 is greater than 50%, in particular approximately 60%.

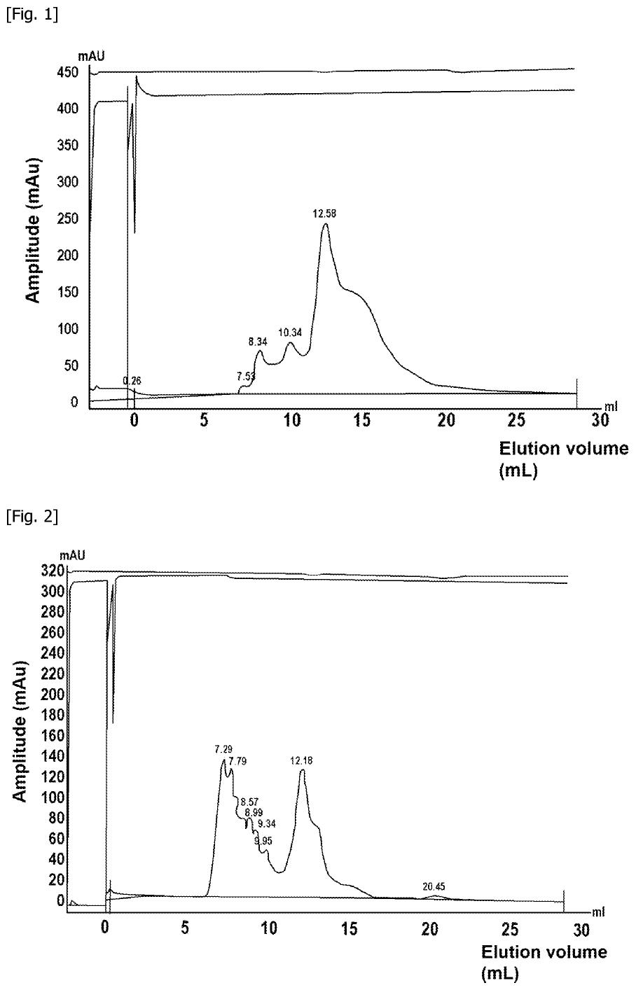

The comparison of FIGS. 1 and 2 makes it possible to observe that the elution profile shifts towards the left in FIG. 2, which indicates an increase in the peaks for larger-size molecules, concerning the trimers/oligomers.

c) Determination of the Molecular Weight (Daltons)

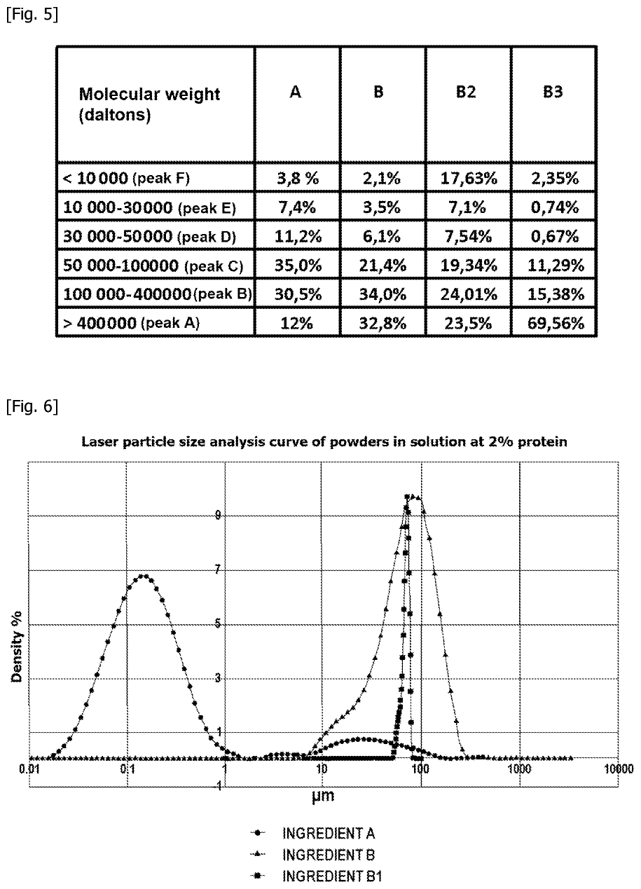

In the context of this analysis, we injected various known molecular weight markers that are suitable for the specific properties of the column, so as to obtain a reliable calibration for analysis of the samples. The markers used are recommended for calibration of the column by GE Healthcare, but also by PSS (Supplier of the software for determining the molecular weight distribution). The concentrations were determined following the response test in terms of amplitude of the signal as a function of injected concentrations, the most adequate were kept for each of the standards, as follows: aprotinin (6500 daltons, 1 mg/ml), ribonuclease (13,700 daltons, 1 mg/ml), ovalbumin (44,000 daltons, 20 mg/ml), conalbumin (75,000 daltons, 20 mg/ml), ferritin (440,000 daltons, 1.2 mg/ml), thyroglobulin (669,000 daltons, 20 mg/ml) originating from the GE Healthcare kit (ref. 28-4038-41), two calibration standards: a first for beta-lactoglobulin (CAS 9045-23-2) at 35,000 daltons, 20 mg/ml and a second for IgG from bovine serum at 150,000 daltons, 10 mg/ml, were added in order to refine the results. Once this calibration had taken place, the data collected for each standard were processed by the UNICORN 7 software. The recorded profiles were then imported into the PSS WINGPC Unichrom software in order to obtain a calibration curve directly established by this software. Once the method was created and recorded in the PSS software, in the same way, the chromatographic profiles for powder A and the solid ingredients B, B1, B2 or B3 were imported, and the results for the tables in FIGS. 4 and 5 could be obtained.

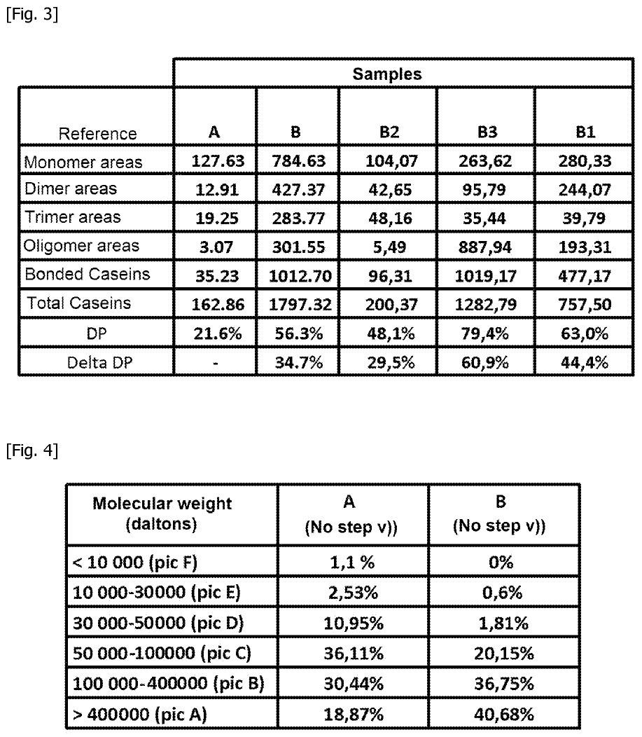

It is observed that the spray drying step for production of the ingredient as a powder modifies its molecular weight distribution, in particular reducing by approximately 10 percentage points the proportion of the ingredient having proteins for which the molecular weights are greater than 400,000 daltons. The proportion of proteins in the ingredient (before or after spray-drying step v)) having molecular weights greater than 400,000 daltons is greater by approximately 20 percentage points than that of the control A, which corroborates a moderate degree of cross-linking, namely of order 30%-45% (cf. FIG. 3).

II—Production of an Example of Low-Fat Set Yoghurt

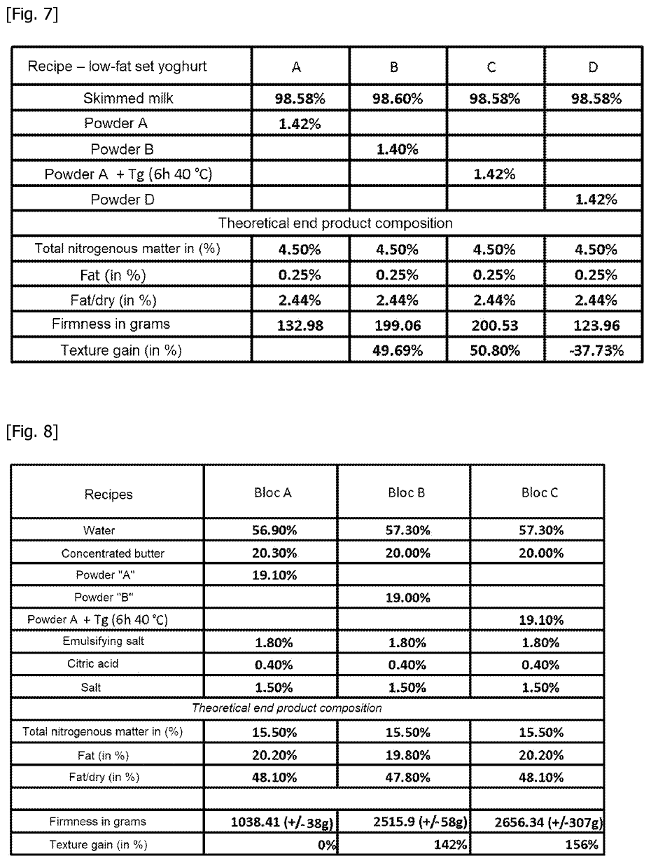

Five types of low-fat set yoghurts were produced: a yoghurt A with a native casein concentrate A (powder A); a yoghurt B with the ingredient according to the invention B (powder B); a yoghurt C produced by adding the liquid composition obtained according to the method of the invention at step iv) before transformation into a powder, directly into milk, denoted liquid C; and a yoghurt D with the ingredient B3 (prepared with a dose of transglutaminase at 3 U/g of TNM), denoted D (powder D). The various compositions and texture results are listed in the table of FIG. 7.

The set yoghurts were produced by each implementing the following method: skinned milk was mixed in the tank of a carousel at 50° C. When the mixture reaches 50° C., the powder A, B, D or the liquid C, is added while stirring; the mixture is passed to the tubular pasteurised (flow rate: 200 L/h; preheating to 70° C., homogenisation at 70° C. with a first homogenisation head applying 50 bar then a second homogenisation head at 100 bar, heating to 92° C. then chambering for 5 minutes, cooling to 48° C.); recovering the mixture in a disinfected bucket; adding the starter cultures (YF-L812, 50 U/250 L of mixture) then mixing; then placing the yoghurts in pots (approximately 125 g of mixture per pot), capping the pots using a heat sealer, incubating the pots at 43° C. for a period of approximately 4 hours, stopping the incubation when the pH reaches a value of 4.65±0.05, storing the pots in a cold room for at least 6 days before performing the tastings and various analyses.

The texture management of the product is carried out using the TA.XTplusC, (Stable Micro Systems, UK) texture analyser at D+7. This texture analyser evaluates the force in grams required to deform the product by penetration of a module. For set yoghurts, the reference geometry SMSP/25P and a cylindrical shape were used, at a penetration speed on the product of 1 mm/s, over a distance of 20 mm and at an extraction speed of 10 mm/s.

After the texture measurements indicated in the table of FIG. 7, it was observed that the cross-linked yoghurts B and C had moreover gained 50% in texture relative to the non-cross-linked control yoghurt A.

Yoghurt B according to the invention has a firmness equivalent to a yoghurt C produced with the addition of transglutaminase for the production method. It is observed that yoghurt D with a dosage of transglutaminase ten times larger than for yoghurt B does not increase the texture but, by contrast, reduces it.

Results equivalent to the results obtained with ingredient B were found for the production of a low-fat set yoghurt produced with solid ingredient B1.

III—Fabrication of a Block Cheese to be Sliced

A series of blocks are prepared: a control block A containing a native casein concentrate A (powder A), a block B comprising ingredient B as a powder according to the invention, and a block C comprising the liquid composition obtained according to the method of the invention at step iv) before its transformation into a solid, denoted liquid C.

The blocks to be sliced were produced by implementing the following method: the concentrated butter is added to mains water in the tank of a Stephan 5L (UMSK_5), the assembly is then heated in a jacketed vessel. When the mixture reaches 50° C., powder A, B or liquid C is added to the mixture, as well as citric acid, salt and emulsifying salt (C Special); stirring the assembly using the Stephan at 50° C. (300 rpm); after one minute, checking the pH, the target pH must be between 5.6 and 5.8; proceeding to the pasteurisation treatment (80° C. for 15 seconds, heating in a jacketed vessel, knife speed at 600 rpm); recovering the mixture in a cake mould without prior cooling; storing the moulds in a cold room for at least 6 days before performing the tastings and various analyses.

The extra measurement is carried out using the TA.XTplusC texture analyser (Stable Micro Systems, UK). This texture analyser evaluates the force in grams required to deform the product by penetration of a module. For the blocks to be sliced, the geometry used is referenced HDP/BS and has the shape of a slicer, at a penetration speed on the product of 2 mm/s, over a distance of 18 mm and at an extraction speed of 10 mm/s. The compositions and results of the tests carried out on the blocks to be sliced A, B and C are listed in the table of FIG. 8. According to the texture measurement, it is observed that blocks A are less firm than blocks B and C. The standard deviation is large for blocks C, in contrast to blocks B for which the texture performances are therefore more reproducible.

It should be noted that when the blocks tested above comprise, in their compositions, 20 wt % of cheddar, the firmness tests are similar to the blocks without cheddar.

IV—Producing an Aluminium Triangle Portion of Spreadable Processed Cheese

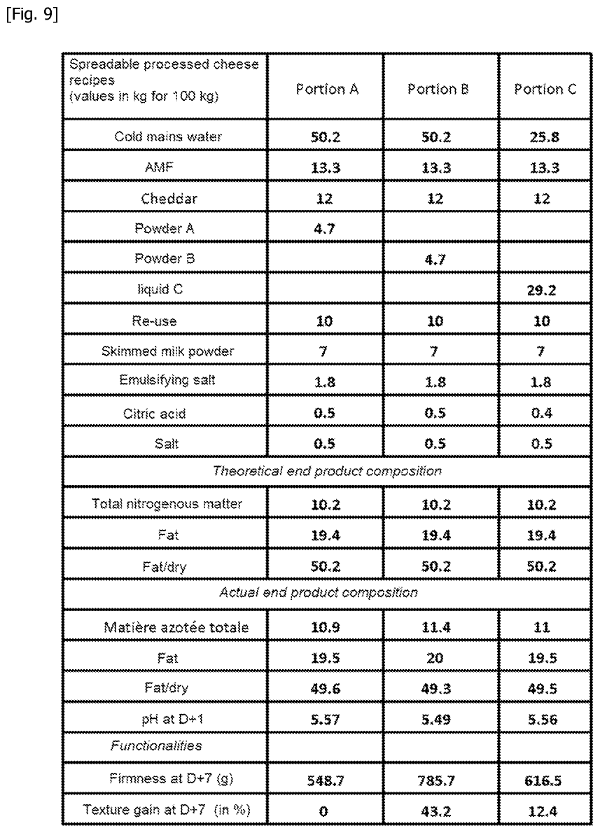

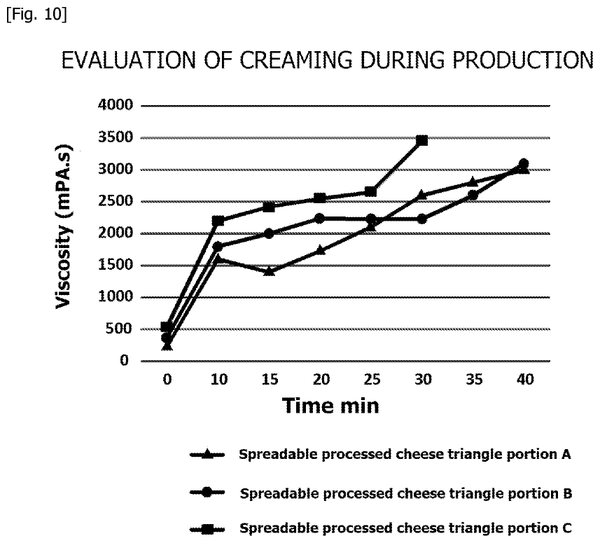

Three types of triangle portions were produced: a first control portion A with a non-cross-linked native casein powder A (powder A), a second portion B with the ingredient according to the invention B (powder B), and a third portion C with the liquid composition obtained according to the method of the invention at step iv) before its transformation into a solid, denoted liquid C. The triangle portion of spreadable cheese was produced by implementing the following method: all the ingredients, except for citric acid, are added in the tank of a Stephan (type UMSK 24 E), the assembly is then ground at 1500 rpm for 5 minutes using the sharp knives of the equipment. When this step is ended, adding the citric acid necessary for achieving the target pH and mixing the assembly using the Stephan at 1500 rpm for 2 minutes; then checking that the value of the pH is indeed between 5.5 and 5.6 then starting the thermal treatment by injecting steam so as to reach 95° C. with a knife speed adjusted to 1500 rpm; once this temperature is reached, continuing to stir for 5 minutes, still at 1500 rpm; then starting the creaming step which consists of an increase in viscosity of the mixture during a stirring step carried out in the tank of the Stephan at 500 rpm at a temperature between 81° C. and 84° C. The viscosity was monitored using a Lamy viscometer (model RM 100, portable, gradient 50 s-1, module MK R4). When the viscosity is sufficiently large, in other words when the value obtained reaches 3000 to 3500 mPa·s-1, the packaging can then be performed in aluminium triangle portions, but also into sealed pots; the end product is then cooled slowly to 60° C. for 1 hour before being stored in a cold room at 4° C. for at least 6 days before carrying out the tastings and various analyses. The compositions and results of the tests carried out on the blocks to be sliced A, B and C are listed in the table of FIG. 9. A texture measurement on the finished product packaged in a pot is carried out using a TA.XTplusC texture analyser (Stable Micro Systems, UK). This can evaluate the force in grams required to deform the product by penetration of a module. The spherical geometry SMS P/1S is used, at a penetration speed on the product of 2 mm/s, over a distance of 10 mm and at an extraction speed of 10 mm/s. The firmness measurements carried out after 7 days following production are listed in the table of FIG. 9. The expression “re-use” in the table of FIG. 9 corresponds to a portion of spreadable processed cheese from the preceding production. It is observed that spreadable processed cheese A is less firm than the spreadable processed cheeses B and C. Advantageously, spreadable processed cheese B is firmer than spreadable processed cheese C. The viscosity measurements carried out during the creaming step on the day of production are listed in FIG. 10. Advantageously, the creaming of the spreadable processed cheese B is quicker than for spreadable processed cheese A or spreadable processed cheese C.

V—Producing a Block Cheese to be Sliced without Emulsifying Salt

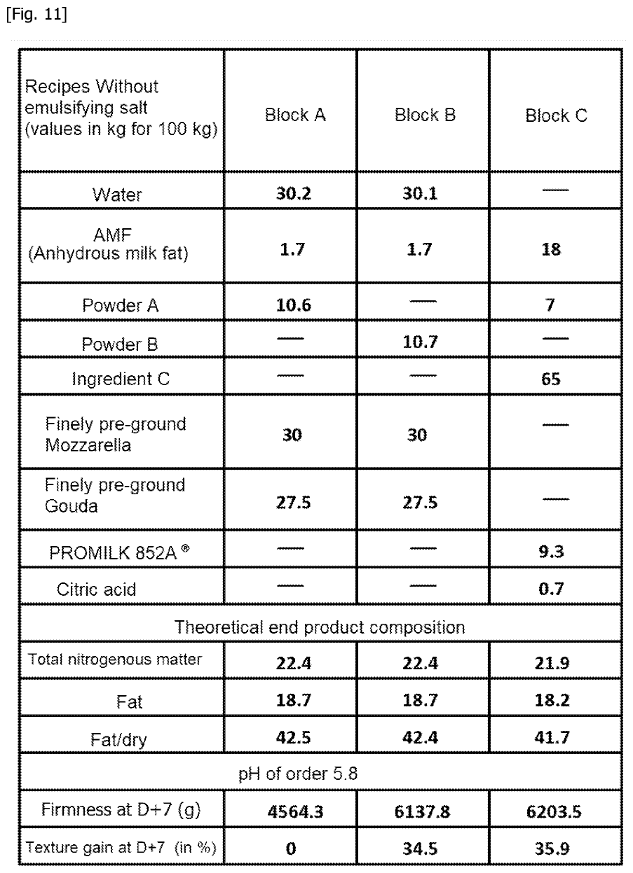

Three types of block were produced: a first block A with a native casein concentrate A as a powder (powder A), a second block with the ingredient according to the invention B (powder B), a third block C with the liquid composition obtained according to the method of the invention at step iv) before its transformation into a solid, denoted liquid C. The various compositions and texture results are listed in table 1. The blocks to be sliced were produced by implementing the following method: animal milk fat is added to mains water (if the recipe contains this) or with the liquid C in the tank of a Stephan (UMSK_5), the assembly is then heated in a jacketed vessel. When the mixture reaches 50° C., powder A or B is added to the mixture, as well as all the other ingredients of the recipe; stirring the assembly using the Stephan at 50° C. (1500 rpm) for 10 minutes then checking that the pH meets the target of 5.25 to 5.45; proceeding to the pasteurisation treatment (76° C. for 3 to 4 minutes, heating in a jacketed vessel, knife speed at 1500 rpm); recovering the mixture in a cake mould without prior cooling; storing the moulds in a cold room for at least 6 days before performing the tastings and various analyses. The texture measurement of the product is carried out using the TA.XTplusC, (Stable Micro Systems, UK) texture analyser. This texture analyser evaluates the force in grams required to deform the product by penetration of a module. For the blocks to be sliced, the geometry used is referenced HDP/BS and has the shape of a slicer, at a penetration speed on the product of 2 mm/s, over a distance of 18 mm and at an extraction speed of 10 mm/s. The compositions and results of the tests carried out on the blocks to be sliced A, B and C are listed in the table of FIG. 11. Block A is less firm than blocks B and C. Blocks B and C have a similar firmness.

VI—Production of a High-Protein Beverage

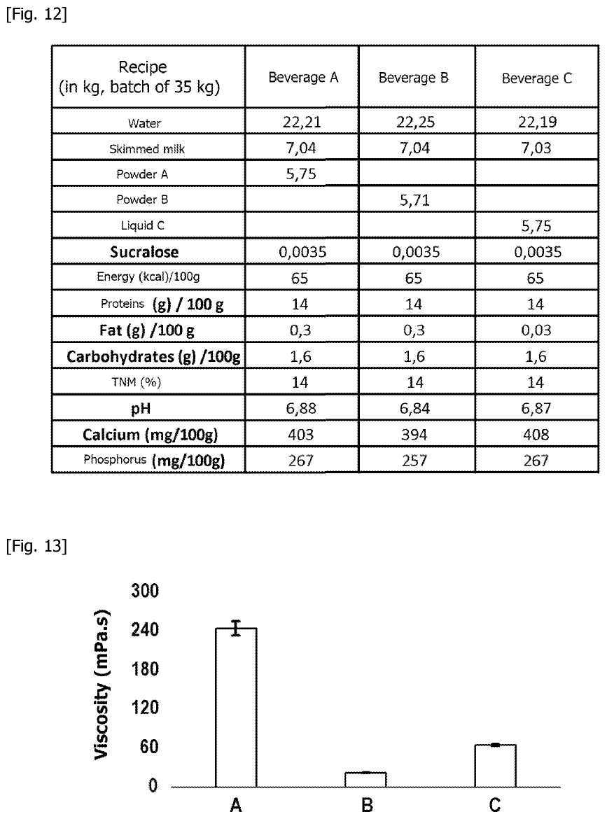

Three high-protein beverages comprise water, skimmed milk and a native casein concentrate A as a powder (powder A) for beverage A, the ingredient according to the invention B (powder B) for beverage B, the liquid composition obtained according to the method of the invention at step iv) before its transformation into a solid, denoted liquid C, for beverage C. A dispersant, such as sodium hexametaphosphate is used at a level of 0.04 wt % of the total mass of the beverage for a protein concentration of 15% or 17%. The precipitated powders A and B are dissolved to different mass concentrations of proteins in water at 50° C. for 1 hour, the solutions A and B, and the liquid C are then preheated to 70° C., and then homogenised at 230 bar and sterilised at ultra-high temperature (for example 143° C. for 4 seconds). The compositions of beverages A, B and C are listed in the table of FIG. 12.

The concentrations by mass of proteins of the high-protein beverages are 14%, they can be between 10% and 17%, preferably for an energy value less than or equal to 100 kcal/100 ml. The pH is preferably greater than 6, in particular greater than or equal to 6.5. Tests have been carried out with beverages B for 10 wt % and 17 wt % of proteins, which have viscosity results similar to those obtained for beverage B at 10 wt % of proteins.

In FIG. 13, it is observed that beverage A is highly viscous, approximately 245 mPa·s whereas beverage B has a very low viscosity of order 22 mPa·s, which represents a gain in fluidity of 91. The viscosity of beverage C is of order 60 mPa·s. The gain in viscosity of beverage B relative to beverage C is thus of order 60%.

The viscosities were measured as described above in the present document, at a temperature of 20° C.

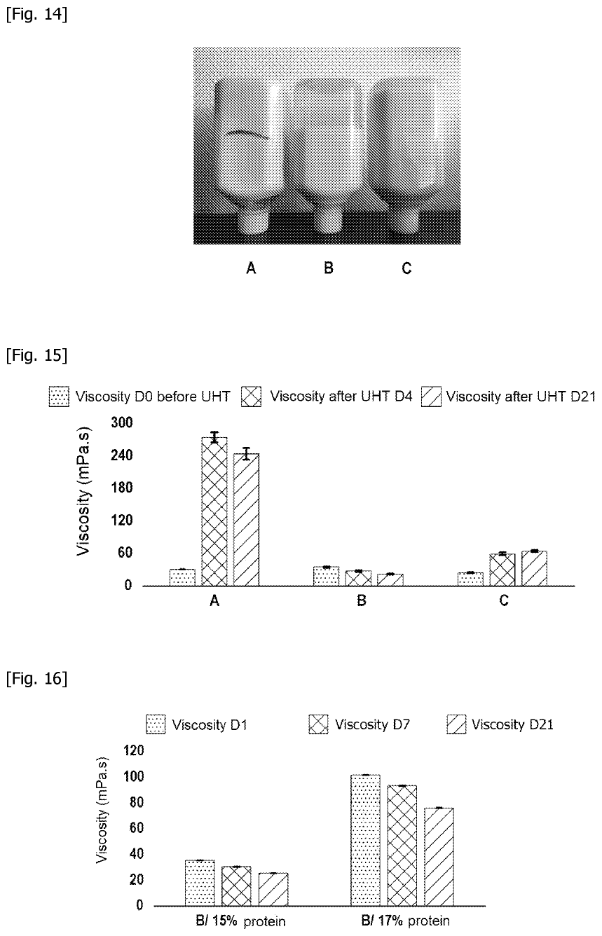

In FIG. 14, it is observed that at the end of one month of storage, beverage A is completely gelled and beverage C is slightly gelled, whereas beverage B is liquid, homogenised and without deposit on the base.

In FIG. 15, it is observed that before UHT sterilisation (Ultra-High Temperature), beverages A, B and C have a low viscosity, less than 50 mPa·s. After UHT sterilisation, the viscosity was measured at 0 days, 4 days and 21 days. Beverages B and C have good viscosity stability over time. Beverage A is not heat stable and the viscosity increases very strongly after UHT sterilisation. The stability of the fluidity gain for beverage B is likewise confirmed relative to beverage C.

FIG. 16 shows the viscosities measured on a beverage B for which the mass concentrations of proteins are increased to 15% and 17%. Advantageously, it is observed that, even for the highest concentration, the viscosity remains less than 100 mPa·s and this in a durable way at the end of 21 days after UHT sterilisation.

VII—Production of a Fromage Frais Foam without Gelatine

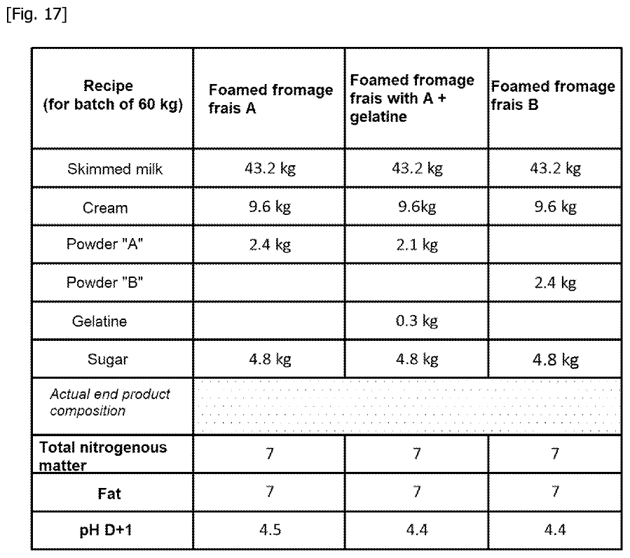

Three fromage frais foams are produced: a first control foam A with a native non-cross-linked casein powder (powder A) without gelatine, a second control foam A11 representative of the market with a native non-cross-linked casein powder (powder A) with gelatine, and a third foam B with the ingredient according to the invention B (powder B). The various compositions of fromage frais are listed in the table of FIG. 17.

The fromage frais foams were produced by implementing the following method: first, heating skimmed milk and cream in the tank of a carousel; then, when the mixture reaches 50° C., powder A, with or without gelatine, or powder B, is then added and the mixture is stirred for one hour; thermally treating the mixture using a tubular pasteuriser; recovering the mixture in a disinfected bucket; adding the lactic acid starter cultures (mix of mesophiles/thermophiles dosed at 10 g/100 kg of mixture) and the coagulant (microbial enzyme at 205 IMCU dosed at 1.4 mL/100 kg of mixture) then mixing sufficiently to homogeneously distribute the starter culture and the coagulant before incubation of the buckets at 32° C.; stopping the incubation when the pH reaches a value of 4.65 t 0.05 then breaking the texture with a curd smoother (Pierre Guerin, ALM2) before cold storage at 4° C. The next day, once the cheese bases have cooled, adding the sugar and mixing sufficiently to distribute it homogeneously; then passing each base on an aeration apparatus (Mondomix, 1998, type K-004.1-CCB5) and packaging in pots at the outlet of the apparatus when the aeration value is between 25 and 30% then storing at 4° C. for at least 6 days before carrying out the tastings and various analyses.

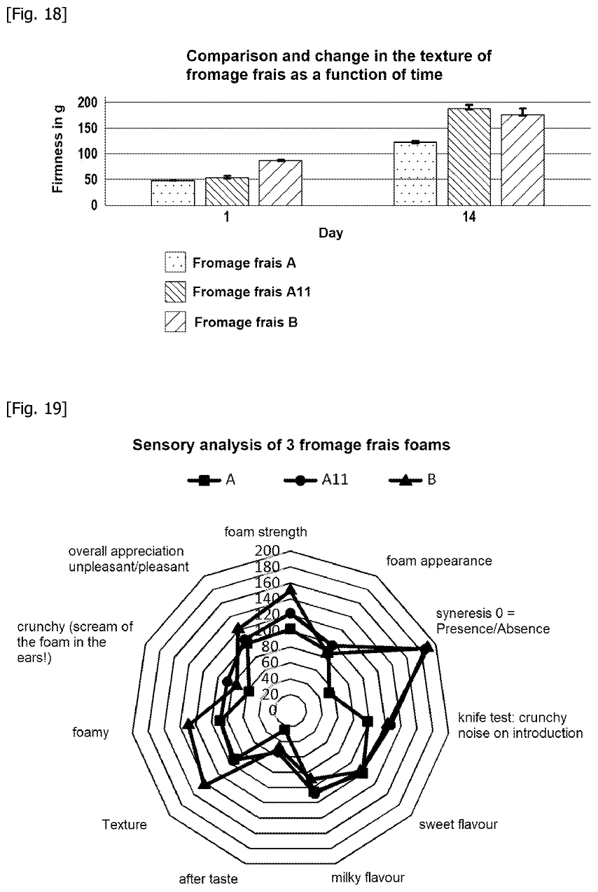

A texture measurement on the finished product is carried out using a TA.XTplusC texture analyser (Stable Micro Systems, UK). This can evaluate the force in grams required to deform the product by penetration of a module. The cylindrical geometry referenced SMS P/25P is used, at a penetration speed on the product of 1 mm/s, over a distance of 20 mm and at an extraction speed of 10 mm/s. The results of the tests carried out on the aerated cheeses A, A11 and B are listed in FIGS. 18 and 19.

Cheese A is less firm than cheeses A11 and B, and this over a period of at least 14 days. The firmness of aerated cheese with gelatine A11 is similar to that of aerated cheese B without gelatine. Ingredient B according to the invention thus advantageously enables an aerated fromage frais without gelatine to be obtained.

A triangular tasting took place on D+14 on the three samples A, A11 and B, with a panel of 20 tasters: 5 tasters noticed a distinction: according to standard ISO 4120:2004 (“Sensory analysis—Methodology—Triangle test”), we can therefore conclude that there was a perceptible sensory difference between the 2 samples with an error risk of 0.1%.

VIII—Production of a Cream Cheese

Three types of cream cheese were produced: a cream cheese A with a native non-cross-linked casein powder A (powder A), a cream cheese B with the ingredient according to the invention B (powder B), and a cream cheese C with the liquid composition obtained according to the method of the invention at step iv) before its transformation into a solid, denoted liquid C. The cream cheese was produced by the following method: mixing skimmed milk and cream in the tank of a carousel at 50° C.; when the mixture reaches 50° C., adding, while stirring, powder A or B or the liquid C with the skimmed milk powder, then allowing to hydrate at 50° C. for 1 hour under gentle stirring; pasteurising the product obtained using a plate pasteuriser (with preheating to 72° C., then a homogenisation step at 72° C. and 100 bar on two homogenisation heads); chambering at 92° C. for 5 minutes; and cooling to 32° C.; introducing the product into a disinfected bucket; adding the starter cultures (10 g of Creamy 1.0 starter culture for 100 kg of product to be treated), and pressing it (Chymax+ at a rate of 1.4 ml per 100 kg of product to be treated) and mixing; incubating at 32° C. overnight in order to obtain a quark; breaking the texture of the quark using a curd smoother (Pierre Guerin, ALM2, head 160) and using the base as formulation ingredient for the second step in Stephan (type UMSK 24 E); preheating the quark to 50° C. while stirring; adding salt; thermally treating at 80° C. for 10 seconds while stirring then passing the product over the curd smoother (Pierre Guerin, ALM2, head 280); finally recovering the product at the outlet of the smoother in pots of cream cheese then storing at 4° C. for at least 6 days before carrying out the tests.

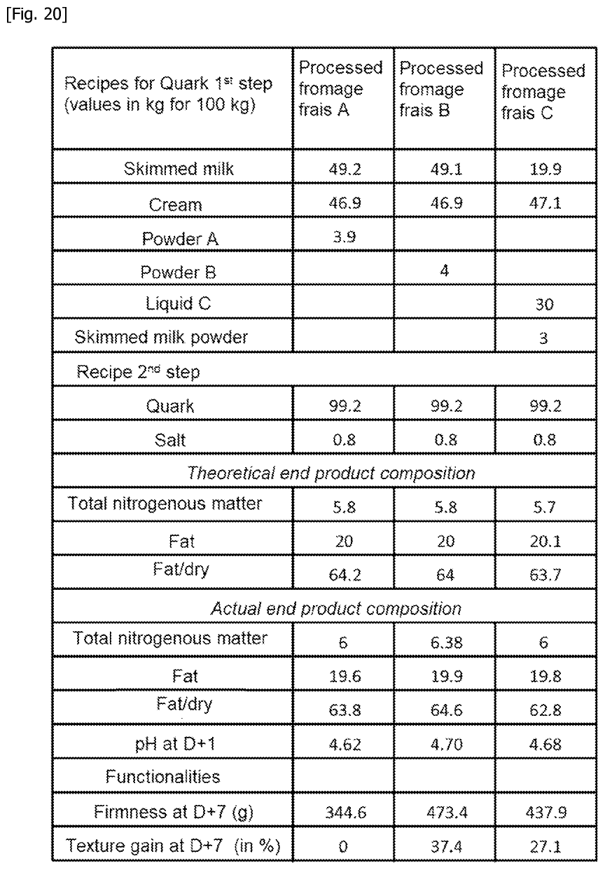

A texture measurement on the finished product is carried out using a TA.XTplusC texture analyser (Stable Micro Systems, UK). This can evaluate the force in grams required to deform the product by penetration of a module. The spherical geometry SMS P/1S is used, at a penetration speed on the product of 2 mm/s, over a distance of 10 mm and at an extraction speed of 10 mm/s. The compositions and results of tests carried out on cream cheese A, B or C are listed in the table of FIG. 20. Cream cheese A is less firm than cream cheese B and C. Cream cheese B enables a texture gain greater than that of cream cheese C.

IX—Production of a Processed Fromage Frais

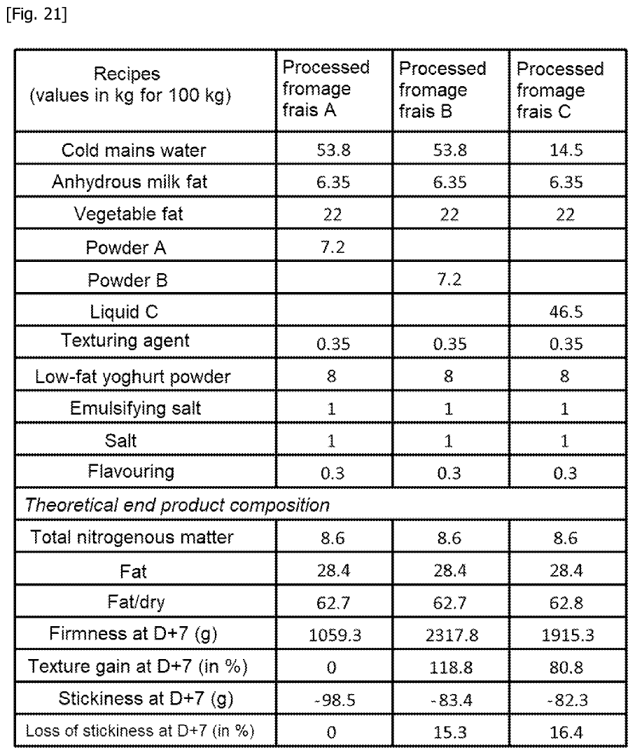

Three types of processed fromage frais were produced: a processed fromage frais A with a native non-cross-linked casein powder A (powder A), a processed fromage frais B with the ingredient according to the invention B (powder B), and a processed fromage frais with a retentate of liquid casein cross-linked with transglutaminase C (liquid C). The processed fromage frais was produced by implementing the following method: animal and vegetable dairy fats are added to mains water in the tank of a Stephan (UMSK_5) then the assembly is heated in a jacketed vessel. When the mixture reaches 50° C., powder A, B or liquid C is added to the mixture, as well as all the other ingredients of the recipe; the assembly is stirred using the knives of the Stephan at 3000 rpm; after five minutes of stirring, checking the pH, this must be between 5.5 and 5.7; proceeding to the thermal treatment in order to reach 95° C. via heating in a jacketed vessel with a knife speed adjusted to 1500 rpm; once the temperature of 95° C. is reached, mixing for five minutes always while stirring at 1500 rpm. Smoothing can then be carried out on the mixture by means of a curd smoother (Pierre Guerin, ALM2, head 180); packaging at the output of the smoother into pots with slow cooling for one hour at 60° C. then storing in a cold room for at least 6 days before carrying out the analyses. A texture measurement on the finished product is carried out using a TA.XTplusC texture analyser (Stable Micro Systems, UK). This can evaluate the force in grams required to deform the product by penetration of a module. The spherical geometry referenced SMS P/1S is used, at a penetration speed on the product of 2 mm/s, over a distance of 10 mm and at an extraction speed of 10 mm/s. This test can also estimate the sticky aspect of the processed fromage frais by evaluating the force in grams necessary for removing the module present in the processed fromage frais during the extraction phase, when the negative values are obtained. The compositions and results of tests carried out on processed fromage frais A, B or C are listed in the table of FIG. 21.

Processed fromage frais B and C are firmer and less sticky than processed fromage frais A. Moreover, processed fromage frais B has a texture gain greater than that of processed fromage frais C.

1. A method for producing a solid food ingredient wherein said method-t comprises the following steps:
i) providing a liquid dairy composition comprising at least 50 wt % caseins relative to its total dry mass, and comprising at most 20 wt % fat(s) relative to its total dry mass;
ii) adding at least one transglutaminase to the composition of step i), at a dose less than or equal to 3 units per gram of total nitrogenous matter (TNM);
iii) at least partially cross-linking the caseins of the liquid composition comprising said at least one transglutaminase;
iv) inactivating said at least one transglutaminase;
v) transforming the liquid composition obtained after step iv) into a solid ingredient;
vi) obtaining said solid ingredient.

2. The production method according to claim 1, wherein the liquid composition at step iii) has a pH greater than or equal to 5.0.

3. The production method according to claim 1, wherein the temperature of the liquid composition at step iii) is greater than or equal to 0° C. and less than or equal to 55° C.

4. The production method according to claim 1, characterised in that the duration of step iii) is greater than or equal to 30 minutes.

5. The production method according to claim 1, wherein said method comprises a step of pasteurising the liquid composition of step i) before step ii).

6. The production method according to claim 1, wherein step v) comprises a step of spray drying.

7. The production method according to claim 1, wherein the degree of cross-linking of proteins in the solid ingredient is greater than 0% and less than or equal to 70%.

8. The production method according to claim 1, wherein the liquid composition at step i) comprises at least 70 wt % total nitrogenous matter (TNM) relative to its total dry mass.

9. The production method according to claim 1, wherein the liquid composition at step i) comprises at most 10 wt % fat(s) relative to its total dry mass.

10. The production method according to claim 1, wherein the solid ingredient obtained at step vi) comprises at least 70 wt % total nitrogenous matter relative to its total dry mass.

11. The production method according to claim 1, wherein the solid ingredient obtained at step vi) comprises at least 70 wt % caseins relative to its total dry mass.

12. The production method according to claim 1, wherein the liquid composition at step i) comprises at least 1 wt % calcium relative to its total dry mass.

13. The production method according to claim 1, wherein the solid ingredient obtained at step vi) comprises at least 1 wt % calcium.

14. The production method according to claim 1, wherein at most 60% of the proteins of the liquid composition after step iii) have molecular weights greater than or equal to 400,000 daltons.

15. A solid food ingredient obtainable by the production method according to claim 1.

16. The solid food ingredient according to claim 15, wherein at most 50% of the proteins of said solid ingredient have molecular weights greater than or equal to 400,000 daltons.

17. A production method of a dairy product, said dairy product being chosen from at least one of the following lists:
list I consisting of: stirred yoghurts, steamed yoghurts, thermised yoghurts, drinkable yoghurts, yoghurt foams, stirred and steamed fermented milks, soft cheeses, fromage frais, pasta filata cheeses, spreadable cheeses, uncooked pressed cheeses, semi-cooked pressed cheeses, cooked pressed cheeses and any dairy product obtained by implementing a method comprising a step of coagulation during which the pH is lowered, or a combination thereof;
list II consisting of: dairy products not comprising a step during which the pH is lowered;
and list III consisting of: protein beverages, protein gels, protein bars, extruded products, or a combination thereof; wherein said production method comprises the use of the solid food ingredient according to claim 15.

18. The production method according to claim 17, wherein the dairy product is chosen in at least one of the list I and list II, and wherein the mass fraction of said ingredient relative to the total mass of said dairy product is greater than 0% and less than or equal to 10%.

19. The production method according to claim 17, wherein the dairy product is chosen from list III and wherein the mass fraction of said ingredient relative to the total mass of said dairy product is greater than 10% and less than or equal to 30%.

20. A texturising agent for a dairy product wherein said texturising agent is the solid food ingredient of claim 15.

21. An agent improving the fluidity of protein beverages, wherein said agent is the solid food ingredient according to claim 15.

22. An agent for the production of processed cheeses without emulsifying salt, wherein said agent is the food ingredient according to claim 15.

23. A thickener agent for a dairy product wherein said thickener agent is the solid food ingredient according to claim 15.
